(19) United States
(12) Patent Application Publication
(10) Pub. No.: US 2026/0087334 A1
(43) Pub. Date: Mar. 26, 2026

(54) COMPUTING DEVICE INCLUDING LARGE-SCALE PRE-TRAINED ARTIFICIAL INTELLIGENCE MODEL FOR OBJECT DETECTION, OBJECT DETECTION METHOD, AND TRAINING METHOD OF TASK-SPECIFIC ADAPTATION NETWORK

(71) Applicant: ELECTRONICS AND TELECOMMUNICATIONS RESEARCH INSTITUTE, Daejeon (KR)

(72) Inventors: Kimin Yun, Daejeon (KR); Hyungil Kim, Daejeon (KR); Kang Min Bae, Daejeon (KR); YU SEOK BAE, Daejeon (KR); Joong-won Hwang, Daejeon (KR)

(21) Appl. No.: 19/328,748

(22) Filed: Sep. 15, 2025

(30) Foreign Application Priority Data
Sep. 23, 2024 (KR) 10-2024-0128297
Sep. 2, 2025 (KR) 10-2025-0123813

(51) Int. Cl. G06N 3/0499; G06N 3/08; G06T 9/00; G06V 10/25

(52) U.S. Cl. CPC G06N 3/0499; G06N 3/08; G06T 9/00; G06V 10/25; G06V 2201/07

(57) ABSTRACT

A computing device is provided. A large-scale pre-trained artificial intelligence (AI) model executed by the computing device includes a multimodal model configured to process different modality inputs including an input image and an input text and an adapted embedding vector specific to a user task to perform the object detection and a task-specific adaptation network configured to generate the adapted embedding vector and provide the adapted embedding vector to the multimodal model, based on an embedding transformation operation on an image embedding vector and a text embedding vector respectively corresponding to the input image and the input text input from the multimodal model.

### CROSS-REFERENCE TO RELATED APPLICATIONS

This application claims the benefit of the Korean Patent Application No. 10-2024-0128297 field on Sep. 23, 2024 and 10-2025-0123813 filed on Sep. 2, 2025, which is hereby incorporated by reference as if fully set forth herein.

### BACKGROUND

### 1. Field of the Invention

The present disclosure relates to a large-scale pre-trained artificial intelligence model, and more particularly, to a large-scale pre-trained artificial intelligence model used for object detection.

### 2. Description of Related Art

Object detection technology is a representative example of image understanding technology using artificial intelligence (AI), and performance thereof has been continuously enhanced by using a massive image data set. However, such a data set requires large-scale labeling, and a range of data capable of labeling is actually limited therein. For example, common objects in context (COCO) data set concentrates in about 80 predefined object classes, and due to this, there are many cases where research and training are performed within a corresponding range.

Recently, as a multimodal AI model for simultaneously processing language and visual information has been developed, a massive amount of test-based description data has been capable of being used in training. Therefore, meaning assignment using language information has been possible, and unlike conventional closed-set object detection, open-set object detection technology for detecting a new object class undefined is attracting much attention.

However, a current AI model based on open-set object detection does not reach a level which may completely understand all objects and situations. Therefore, it is required to additionally learn a model or perform adaptation through a specialized method, based on the need for detecting a specific object in a task defined by a user (hereinafter referred to as a user task) (i.e., a specific image).

### SUMMARY

An aspect of the present disclosure is directed to providing a computing device including a large-scale pre-trained artificial intelligence (AI) model for object detection, an object detection method, and a training method of a task-specific adaptation network.

To achieve these and other advantages and in accordance with the purpose of the invention, as embodied and broadly described herein, there is provided a computing device including a memory configured to store an instruction for executing and training a large-scale pre-trained artificial intelligence (AI) model performing object detection and a processor configured to execute the instruction, the large-scale pre-trained AI model executed and trained by the processor including: a multimodal model configured to process different modality inputs including an input image and an input text and an adapted embedding vector specific to a user task to perform the object detection; and a task-specific adaptation network configured to generate the adapted embedding vector and provide the adapted embedding vector to the multimodal model, based on an embedding transformation operation on an image embedding vector and a text embedding vector respectively corresponding to the input image and the input text input from the multimodal model.

In another aspect of the present invention, there is provided an object detection method performed by a computing device including a memory configured to store an instruction for object detection and a processor configured to execute the instruction, the object detection method including: a step of generating an adapted embedding vector specific to a user task by using a task-specific adaptation network executed by the processor, based on an embedding transformation operation on an image embedding vector and a text embedding vector respectively corresponding to an input image and an input text input from a multimodal model executed by the processor; and a step of processing the input image, the input text, and the adapted embedding vector by using the multimodal model executed by the processor to perform the object detection.

In another aspect of the present invention, there is provided a training method of a task-specific adaptation network connected to a multimodal model performed by a computing device including a memory configured to store an instruction for training execution and a processor configured to execute the instruction, the training method including: a step of obtaining a zero-shot object detection result of the multimodal model; a step of comparing the zero-shot object detection result with right answer data (ground truth) to calculate an IoU value between the zero-shot object detection result and the right answer data; a step of selecting subset data in learning data by using the calculated IoU value; and a step of training the task-specific adaptation network, based on the selected subset data.

According to embodiments of the present disclosure, unlike a conventional training method based on simple data collection, a model may be adapted to a specific task required by a user while maintaining a performance of a conventional model pre-trained with massive data. Accordingly, effective additional training may be performed with only a small amount of training data, and data having similar and different personalities may also be used, thereby enhancing training efficiency.

Moreover, for example, even in a case which processes various tasks such as “fallen person detection” or “placard detection” in a closed-circuit television (CCTV) environment, a performance of a pre-trained model may be maintained while adapting to a characteristic changed based on each camera or environment. Accordingly, a degradation in performance in a specific environment may be prevented, and moreover, an enhanced result may be obtained.

Furthermore, the present disclosure may maintain an operation path capable of using a zero-shot model, and thus, in a case where a model adapted to a specific task is tested in a completely different environment, a generalization capability of the zero-shot model may be used again. Accordingly, the reusability and flexibility of a model may increase.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a configuration diagram of a user task-specific large-scale pre-trained AI model executed and trained by a computing device according to embodiments of the present disclosure.

FIG. 2 is a configuration diagram of a task-specific adaptation network according to embodiments of the present disclosure.

FIG. 3 is a block diagram illustrating a training process of a task-specific adaptation network according to embodiments of the present disclosure.

FIG. 4 is a flowchart illustrating an object detection method according to embodiments of the present disclosure.

FIG. 5 is a detailed flowchart of step S410 illustrated in FIG. 4.

FIG. 6 is a detailed flowchart of step S420 illustrated in FIG. 4.

FIG. 7 is a flowchart illustrating a training process of a task-specific adaptation network according to embodiments of the present disclosure.

FIG. 8 is a configuration diagram of a computing device for executing and training a large-scale pre-trained AI model performing object detection according to embodiments of the present disclosure.

### DETAILED DESCRIPTION OF THE INVENTION

Reference will now be made in detail to the exemplary embodiments of the present disclosure, examples of which are illustrated in the accompanying drawings. Wherever possible, the same reference numbers will be used throughout the drawings to refer to the same or like parts.

In the following description, the technical terms are used only for explaining a specific embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

First, main terms used herein may be defined as follows, and unless limited, the main terms may be for convenience of description without limiting embodiments of the present disclosure.

The term “user task” used herein may denote an operation having a specific purpose directly defined or designated by the user. In more detail, the user task may denote a target object, an event, or a state which is to be detected or classified by the user, in a specific image, a video, or other data. For example, an operation such as “fallen person detection” or “banner detection” in a closed-circuit television (CCTV) image may be an example of a user task. However, an embodiment of a user task described herein does not limit the present disclosure and may include overall operations of various forms capable of being defined by a user.

The term “modality” used herein may denote a type of data which may be processed as an input or generated as an output by an AI model. For example, a text, a speech, an image, a video, or sensor data may be an example of modality. However, modality according to embodiments of the present disclosure is not limited thereto and may include all of various data representation formats capable of being used.

The term “foundation model for object detection” used herein may denote a model which may be applied to a task associated with object detection among general-use AI models pre-trained based on a massive data set. In more detail, such a model may predict a position of an object in an image in the form of bounding box or mask or in the form similar thereto and may adapt to a new object class or environment, based on pre-trained representation. For example, a CLIP-based model, a ViT-based model, or an Open-set object detector which may process a multimodal input (for example, a text and an image) to perform object detection may correspond thereto, but the present disclosure is not limited thereto.

The term “multimodality representation” used herein may denote numerical representation which is generated by fusing feature vectors or embedding vectors obtained from different modalities (for example, an image, a text, a speech, etc.). The multimodality representation may be implemented in the form of vector, matrix, or tensor and may be used as an input for performing a specific task.

The term “modality combination or modality fusion” used herein may denote an operation of fusing feature vectors or embedding vectors of different modalities to generate single representation.

The term “self-attention operation” used herein may denote an operation of emphasizing a specific feature of input embedding and restraining an undesired feature, and for example, the self-attention operation may denote an operation which calculates Query (Q), Key (K), and Value (V) matrixes on each feature element included in an input embedding vector, calculates a similarity through a dot-product of the Query and the Key, and applies a Softmax function to obtain an attention weight. Subsequently, a weighted sum may be performed by multiplying Value by the attention weight, and thus, a new output vector in which a correlation between feature elements of the input embedding vector is reflected may be generated.

The term “cross-attention operation” used herein may denote an operation of generating an output vector in which a semantic correlation between different modalities is reflected. A cross-attended operation may set, to Query (Q), one of embedding vectors provided from different modalities and may set the other one embedding vector to Key (K) and Value (V) to calculate a similarity through a dot-product of the Query and the Key, may apply a Softmax function to obtain an attention weight, and may multiply Value by the attention weight to perform a weighted sum. For example, when a text embedding vector is set to the Query, and an image embedding vector is set to the Key and the Value, the cross-attended operation may output a cross-attended embedding vector where an image feature corresponding to a text indicator is reinforced.

The term “nonlinear transformation operation” used herein may denote an operation which is performed by combining a linear transformation and a nonlinear activation function on an input vector. For example, the nonlinear transformation operation may include an operation which applies a weight matrix W and a bias b to an input matrix X and applies a nonlinear activation function such as rectified linear unit (ReLU), Sigmoid, or Tanh, and thus, assigns nonlinearity to a relationship between an input and an output. The nonlinear transformation operation may include, for example, a feed-forward network (FFN) operation or a multi-layer perceptron (MLP) operation.

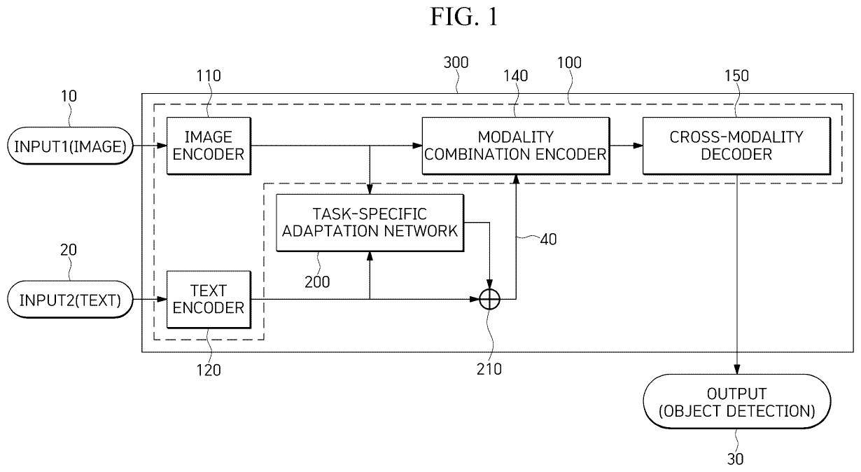

The term “zero-shot object detection result” used herein may denote an object detection result which is performed on input data by large-scale pre-trained AI model (a multimodal model (100 of FIG. 1) unconnected to a task-specific adaptation network 200 described below) without a separate fine tuning operation for user task. The object detection result may include a bounding box representing a position of an object predicted, a class label representing a type of object, and a confidence score representing the reliability of prediction.

The term “zero-shot model” used herein may denote a model which directly calculates a result of input data without performing a separate fine tuning process on a specific task, based on a pre-trained parameter. For example, when a foundation model pre-trained based on a massive data set performs object detection on a new class or task, the foundation model may function as a zero-shot model.

The term “foundation model” used herein may be a model pre-trained based on a massive data set and may denote a general-use model capable of being reused through additional training (fine tuning) or prompt adjustment (prompting), based on various downstream tasks. Like GPT, BERT, CLIP, and ViT, a model corresponding to an image, a text, and multimodal data may be a representative example.

FIG. 1 is a configuration diagram of a user task-specific large-scale pre-trained AI model executed and trained by a computing device according to embodiments of the present disclosure.

Referring to FIG. 1, a user task-specific large-scale pre-trained AI model according to an embodiment may include a multimodal model 100 and a task-specific adaptation network (or a task-specific transformation network) 200 and may further include a combiner 210.

The multimodal model 100 may be a large-scale pre-trained model which processes input modality including an input image and an input text to perform object detection, and for example, may be a foundation model capable of being reused in object detection or a model including an open-set-based object detector. The task-specific adaptation network 200 may be a model which is trained to generate a user task or an output (for example, an adapted embedding vector) corresponding to the user task.

The multimodal model 100 may be configured to include an encoder 100 and 120, a modality combination encoder 140, and a cross-modality decoder 150. A large-scale pre-trained AI model 300 may be configured by adding the task-specific adaptation network 200 to the multimodal model 100.

The encoder 100 and 120 may include an image encoder 110 and a text encoder 120, and the image encoder 110 and the text encoder 120 may be integrated as one encoder.

The image encoder 110 may be configured to transform the input image 10 into an image feature vector or an image embedding vector capable of being used in object detection. For example, the image encoder 110 may be implemented based on an architecture such as a convolutional neural network (CNN) or a vision transformer (ViT), but is not limited thereto.

The text encoder 120 may be configured to transform the input text 20 into a text feature vector or a text embedding vector capable of being used in object detection. For example, the text encoder 120 may include a transformer-based encoder and may be implemented based on an architecture such as bidirectional encoder representations from transformers (BERT) or a GPT-based model, but is not limited thereto.

The task-specific adaptation network 200 may receive outputs (an image embedding vector and a text embedding vector) of the image encoder 110 and the text encoder 120 and may perform an embedding transformation operation to generate an ‘adapted embedding vector 40’ which is trained to reflect a user task well. Here, the embedding transformation operation may include a self-attention operation, a cross-attention operation, and a nonlinear transformation operation, and the self-attention operation, the cross-attention operation, and the nonlinear transformation operation may be sequentially performed on or applied to the image embedding vector and the text embedding vector. The nonlinear transformation operation may include, for example, an FFN operation or an MLP operation.

The adapted embedding vector may be combined with an output (for example, the text embedding vector) of the test encoder 120 by the combiner 210 and may be provided to the modality combination encoder 140. Therefore, text information may be trained to function as an indicator which defines a detection target object, instead of simple auxiliary information. Accordingly, the conventional knowledge of the multimodal model 100 implemented as a foundation model or configured to include an open-set-based object detector may be efficiently used while updating only indicator information.

The modality combination encoder (or a modality fusion encoder) 140 may receive an output (for example, the image embedding vector) of the image encoder 110 and the adapted embedding vector which is generated by the task-specific adaption network 200 and corresponds to the user task and may generate multimodality representation. To this end, the modality combination encoder 140 may be configured to use at least one of a self-attention operation, a cross-attention operation, a multimodal transformer, a joint representation learning method, and other methods, but is not limited thereto.

The cross-modality decoder 150 may be configured to receive an output of the modality combination encoder 140 and perform a decoding operation on the received output to finally generate an object detection result. The decoding operation may analyze the multimodality representation from the modality combination decoder 140 to calculate an object candidate and may determine a final object detection result through a threshold operation. The object detection result may be, for example, an object detection result including a bounding box of an object, a class label, and a confidence score.

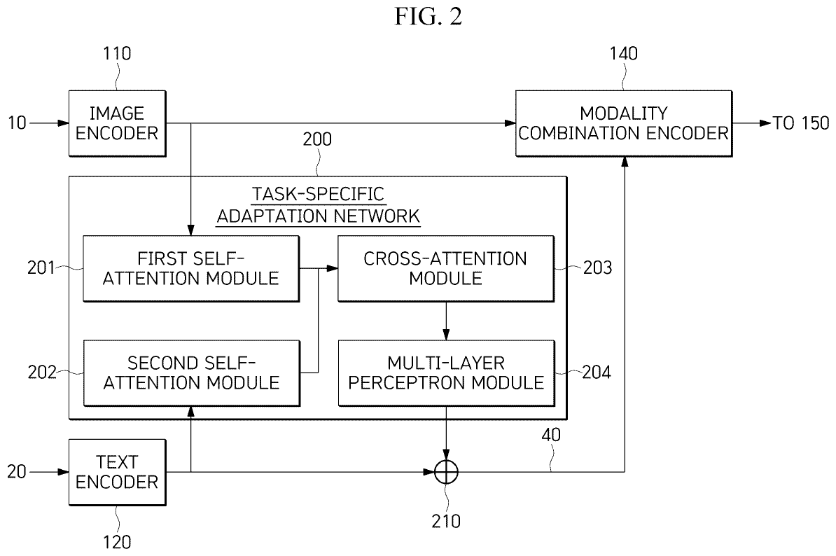

FIG. 2 is a configuration diagram of a task-specific adaptation network according to embodiments of the present disclosure.

Referring to FIG. 2, as described above, the task-specific adaptation network 200 may be configured to receive outputs of the image encoder 110 and the text encoder 120 to generate the adapted embedding vector 40 corresponding to a user task. The task-specific adaptation network 200 may include first and second self-attention modules 201 and 202, a cross-attention module 203, and a multi-layer perceptron (MLP) module 204.

The first self-attention module 201 may analyze a correlation between feature elements of an image embedding vector input from the image encoder 110 through a first self-attention operation, and thus, may emphasize a relatively important feature and may restrain an undesired feature. Therefore, a feature representation of the same modality may be enhanced, and information loss may be minimized in a subsequent processing step. To train the correlation between the feature elements of the image embedding vector, for example, the first self-attention module 201 may calculate Query (Q), Key (K), and Value (V) matrixes, may calculate a similarity through a dot-product of the Query and the Key, and may apply a Softmax function to calculate a weight. Subsequently, an output vector may be generated by performing a weighted sum on Value, based on the calculated weight, and the generated output vector may be normalized through layer normalization (LN), and thus, a finally adapted image embedding vector may be output.

The second self-attention module 202 may analyze a correlation between feature elements of a text embedding vector input from the text encoder 120 through a second self-attention operation, and thus, may emphasize a relatively important feature and may restrain an undesired feature. Therefore, a feature representation of the same modality may be enhanced, and information loss may be minimized in a subsequent processing step. For example, the second self-attention module 202 may calculate Query, Key, and Value matrixes, based on the same method as the first self-attention module 201, and may apply a Softmax-based attention weight to generate an output vector where contextual dependence and semantic evidence are reinforced. At this time, the output vector may be normalized through layer normalization (LN), and thus, an ‘adapted text embedding vector’ finally specific to a user task may be provided. Also, in FIG. 2, the first self-attention module 201 and the second self-attention module 202 are illustrated as independent elements, but are not limited thereto and may be integrated as one self-attention module.

The cross-attention module 203 may receive an output (an adapted image embedding vector) of the first self-attention module 201 and an output (an adapted text embedding vector) of the second self-attention module 202 to learn a semantic correlation (or semantic relevance) between different modalities. For example, the cross-attention module 203 may perform a cross-attention operation so as to reinforce a correlation between a specific object feature of an image and a text indicator and may generate a cross-attended embedding vector as an output through a cross-attention operation. Accordingly, text-based indication information may be effectively reflected in image representation.

The MLP module 204 may receive an output (a cross-attended embedding vector) of the cross-attention module 203 to perform a nonlinear transformation operation based on a nonlinear activation function to generate a ‘finally adapted embedding vector’ specific to a user task. Here, the nonlinear transformation operation may include an FFN operation or an MLP operation.

In this case, the MLP module 204 may be defined as expressed in the following Equation 1.

$$Δ f = FFN ( X ) = ReLU ( {XW}_{1} + {b}_{1} ) {W}_{2} + {b}_{2} \qquad [ Equation 1 ]$$

Here, a rectified linear unit (ReLU) may denote a nonlinear activation function which outputs 0 when an input value is less than 0 and intactly outputs the input value when the input value is greater than or equal to 0, and unlike a linear function, the ReLU may assign nonlinearity to an input-output correlation. Each of W₁ and W₂ may denote a weight matrix capable of learning, and each of b₁ and b₂ may be a bias value capable of learning. Also, Δf calculated through the FFN operation may denote a delta offset of input embedding (for example, a cross-attended embedding vector), and a finally adapted embedding vector \tilde{f} may be obtained by performing layer normalization (LN) after Δf is added to original embedding fₚ as in the following Equation 2.

$$\tilde{f} = LN ( {f}_{p} + Δ {f}_{p} ) \qquad [ Equation 2 ]$$

Therefore, the MLP module 204 may generate an adapted embedding vector so as to be more suitable for a user task while maintaining a generalization performance of original embedding.

As a result, the task-specific adaptation network 200 may apply a delta offset through a self-attention operation, meaning combination between modalities, and nonlinear transformation on image embedding and text embedding, and thus, may provide an adaptation embedding vector specific to a user task capable of being used in the modality combination encoder 140 and the cross-modality decoder 150.

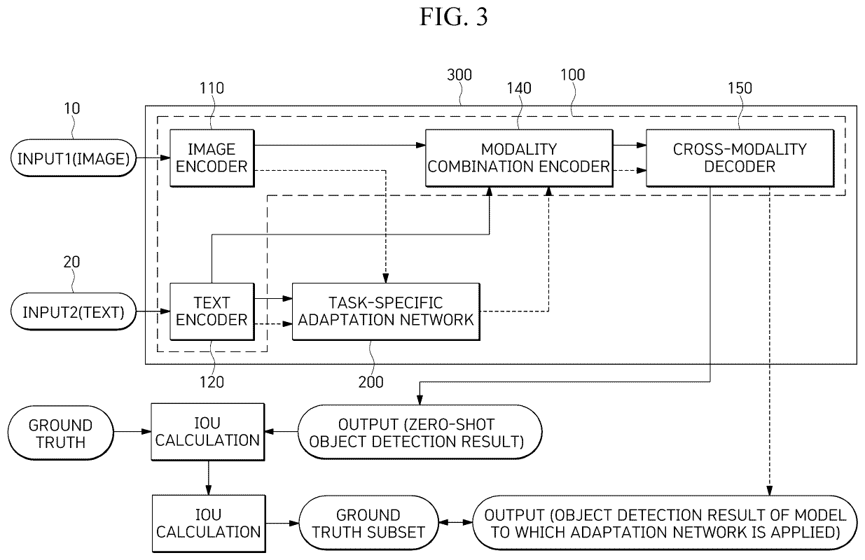

FIG. 3 is a block diagram illustrating a training process of a task-specific adaptation network according to embodiments of the present disclosure.

A solid-line arrow illustrated in FIG. 3 represents a data processing path in a configuration where the task-specific adaptation network 200 is not connected to the multimodal model 100, and a dotted-line arrow represents a data processing path in a configuration where a task-specific adaptation network 200 is connected to the multimodal model 100.

Referring to FIG. 3, first, training of the task-specific adaptation network 200 may be performed in a state where the task-specific adaptation network 200 is connected to the multimodal model 100. In this case, however, when the amount of data specific to a task collected by a user is not sufficient, or a qualitative deviation of the data is large, a generalization performance of the multimodal model 100 may be degraded, and an overfitting problem may occur. As a result, a trained model may have good performance in learning data, but a problem where performance is considerably degraded in a real application environment may occur.

To solve such problems, embodiments of the present disclosure may provide a method which may efficiently train only the task-specific adaptation network 200 while maintaining a generalization performance of the multimodal model 100. In detail, a training method according to embodiments of the present disclosure may include an approach method which selects and learns step-by-step some pieces of learning data (for example, an input image, right answer data corresponding to the input image, and an input text provided along with the input image), instead of learning all learning data at a time.

First, a training process according to the present disclosure may start a step of pre-evaluating a data set collected by a user by using a zero-shot object detection result. In this step, a zero-shot model may output a bounding box and a class label on an input image. Here, the ‘zero-shot model’ may denote the multimodal model 100 which is not connected to the task-specific adaptation network 200.

There may be a case where there is the output bounding box, but the class label is worse, or a position of the bounding box is inaccurate. In this case, right answer data and data including a suitable result of a certain level or more in the zero-shot object detection result may be selected and defined as a right answer data subset (a ground truth subset). Such a data selection process may prevent an excessive characteristic bias (for example, a problem where performance is degraded in a general situation because a very small object is detected) occurring in a data set collected by a user and may expand a capability of a model in a partially corrected form while maintaining a characteristic of a large-scale pre-trained AI model.

The data selection process may be performed as follows. When a bounding box predicted on a specific object overlaps a bounding box of right answer data by a certain level or more, namely, when an intersection over union (IoU) value is greater than or equal to a certain threshold value, the zero-shot model may determine a corresponding prediction result as a reliable result. For example, when there are one or more bounding boxes satisfying the condition in one image, the zero-shot model may select the image as data capable of being used in training.

A ground truth subset according to embodiments of the present disclosure may be divided into EASY data and MEDIUM data for each level of difficulty, based on a magnitude of the IoU value. In detail, when the IoU value is greater than or equal to a first threshold value, a corresponding image may be classified into EASY data, and when the IoU value is a second threshold value or more and less than the first threshold value, a corresponding image may be classified into MEDIUM data. For example, the first threshold value may be se to 0.7, and the second threshold value may be se to 0.5, but the inventive concept is not limited thereto.

In embodiments of the present disclosure, initial training may be preferentially performed by using the EASY data, and thus, a model may stably start task-specific training. Subsequently, the MEDIUM data may be gradually added to expand training, and thus, an overfitting problem may be minimized, and a performance of a model may be progressively enhanced.

Furthermore, a loss function defined in the training process may be set so that the task-specific adaptation network 200 is limited and performs backpropagation. Therefore, a pre-learned parameter of the multimodal model 100 may be maintained in a frozen state, and learning update may be applied to only the task-specific adaptation network 200. Accordingly, a generalization performance of a large-scale pre-trained AI model may be maintained, and only representation training specific to a user task may be selectively reinforced.

Moreover, in embodiments of the present disclosure, a loss function for training may use the same configuration as a loss function which is used in training a pre-trained model. In detail, in a detection model, focal loss may be applied for classification, and L1 loss may be applied for bounding box position regression, thereby performing training. Here, the focal loss may denote a classification loss function which is based on cross-entropy loss and is defined to decrease the loss contribution of a well-classified sample and relatively increase the loss contribution of a difficult sample, and the L1 loss may denote a loss function which calculates a mean absolute error (MAE) of a difference between a right answer value and a prediction value of a model. The application of a loss function may be intactly maintained in a training process which is limited to the task-specific adaptation network 200, and thus, a stable generalization performance of a large-scale pre-trained AI model may be maintained, and a training effect optimized for a user task may be accomplished.

As described above, a training process of the task-specific adaptation network 200 according to embodiments of the present disclosure may prevent overfitting through stepwise training and the difficulty level classification of the EASY data and the MEDIUM data and may limit a training target to only the task-specific adaptation network 200, based on a loss function, and thus, may maintain a generalization performance of a conventional large-scale pre-trained AI model (for example, the multimodal model 100) and may realize model performance specific to a user task.

### EXPERIMENT RESULT

### First Embodiment: Task which Detects a Fallen Person on a Road

The first embodiment of the present disclosure may be an experiment on a task which detects a fallen person on a road. A general object detector may learn massive data of a standing person, but may have a limitation where it is difficult to sufficiently reflect a characteristic of a CCTV domain. For this reason, a conventional method may use a method which massively collects data of a fallen person to fine-tune a network.

The following tables may show results of conventional methods which use about 290,000 pieces of training data called VP290K. The data set may be configured to perform 2-class object detection on a general person and a fallen person.

TABLE 1

| Models for VFP290k dataset | mAP |
|---|---|
| Yolov3 [2] | 59.0 |
| DETR [3] | 60.5 |
| Faster R-CNN [4] | 73.2 |
| Iter-E2EDET [5] | 74.1 |
| Yolov5 [6] | 74.1 |
| DeteroRS [7] | 74.6 |
| H\hat{ }3Net [8] | 74.9 |
| Zero-shot (“person, fallen person”) [1] | 59.9 |
| Zero-shot (“person, person lying down”)[1] | 44.6 |
| Zero-shot (“person, person lying motionless on sidewalk”)[1] | 38.5 |
| Zero-shot (“person, fallen pedestrian on the street”)[1] | 36.9 |
| Zero-shot (“person, person collapsed on the street”)[1] | 48.5 |
| Proposed with data set selection | 81.0 |
| Training with VFP full data set (baseline) | 82.4 |

A proposed method may use, as an initial value, a language-vision model pre-trained with massive data, and a performance thereof may be changed based on an input text (prompt). As a result of testing several candidate texts, a text “fallen person” may have a highest validation performance and may thus be used as an input of an initial model. Subsequently, training has been performed by using a proposed task-specific adaptation network, and in order to maximally use a performance of a pre-trained model, primary training has been performed by selecting a data set, based on a zero-shot result.

The present disclosure may be for specifying a general-purpose usable model to a task desired by a specific user, based on a text input. A primary training step may adjust a model to be suitable for a task while maintaining a characteristic of a conventional model, and a secondary training step may enhance performance by using learning data which is not newly constructed. For example, when training is performed by using all objects (total 863,582 objects) of a VFP data set, a performance of 82.4 mAP may be obtained, but when a test is performed in a domain differing from an IHP data, an overfitting problem may largely occur. On the other hand, by using the proposed method, a performance of 81.0 mAP may be realized with only about ⅛ (total 122,115 objects) of all objects, and this may be a level which is higher than another conventional model.

Moreover, in the proposed method, an additional experiment has been performed by using an IHP data set so as to confirm that an overfitting problem is reduced, and the method has the general purpose available by another similar task. In an experiment, the IHP data set may solve a problem of detecting a fallen person in a CCTV environment, and the degree to which a model trained with only a VP290K data set is well generalized has been evaluated through a cross-test. As a result of experiment, the proposed method may have a performance which is higher than that of the conventional method, and thus, an effect of the present disclosure may be confirmed.

TABLE 2

| Models for IHP dataset | mAP |
|---|---|
| Zero-shot (“person, fallen person”)[1] | 47.8 |
| Zero-shot (“person, person lying down”) | 42.2 |
| Zero-shot (“person, person lying motionless on sidewalk”) | 44.0 |
| Zero-shot (“person, fallen pedestrian on the street”) | 47.9 |
| Zero-shot (“person, person collapsed on the street”) | 48.7 |
| Proposed with data set selection | 70.6 |
| Training with VFP full data set (baseline) | 62.1 |

Unlike the VFP data set, in the IHP data set, it may be seen that a text “fallen person” may not have the highest performance, and based thereon, it may be seen that a performance may be changed according to a task which is targeted. However, in order to perform an equal comparison, by using “fallen person” as an input, an initial model has been set, and a test has been performed. As a result of applying a model trained with the VFP data set to the IHP data set, in a primary training model, a zero-shot performance has been improved from 47.8 into 70.6, and a performance has been enhanced while maintaining a conventional performance. On the other hand, when self-training is applied to VFP data set training, training has been largely biased to a trend of a specific data set, and due to this, a performance has been partially reduced to 68.3. Also, because a model trained with VFP full data set is specific to the VFP data set, the model has shown a result that a performance is reduced to 62.1 in the IHP data set. This may represent that it is important to select and learn data to be suitable for a specific task.

### Second Embodiment: Banner Detection Task Using Public CCTV

The second embodiment of the present disclosure may be an experiment on a banner detection task using a public CCTV. The task may be technology which detects a banner image in a public CCTV video and recognizes the image to compare the image with reported content, and thus, is used as a portion of a system which determines whether there is illegality. A banner data set disclosed in AIHub has been used as learning data for banner detection, and the data set is configured with an image captured at a long distance. When such data is intactly used in training, a problem may occur where a clear banner capable of being easily recognized by a person is not detected because a model is overfitted.

In banner detection, unlike detection of a fallen person, only the banner data of AIHub may be used, and only a test performance may be confirmed at a real application target place. As a result of experiment, an initial zero-shot model has provided a relatively high performance, but it has been confirmed that a performance of the initial zero-shot model is more reduced than a before-training zero-shot model due to an overfitting problem in training where full data is intactly used.

TABLE 3

| Banner detection result performance comparison | mAP |
|---|---|
| Yolov5 + Full data [6] | 23.9 |
| Zero-shot (“banner”) [1] | 58.8 |
| Zero-shot (“outdoor banner”) [1] | 64.5 |
| Finetuning with Full data (baseline) | 61.1 |
| Proposed with data set selection | 71.5 |

By using the proposed method, a model may be adjusted to be suitable for a specific task while maintaining a performance of the zero-shot model, and thus, an overfitting problem may be alleviated while maintaining a generalization performance. Comparing with a conventional method having the overfitting problem, the drawing shows the degree to which a performance of the proposed method is improved. Based on such a method, a model may more accurately detect a banner, and thus, the present disclosure may be effectively applied to an illegal banner detection system based on a public CCTV.

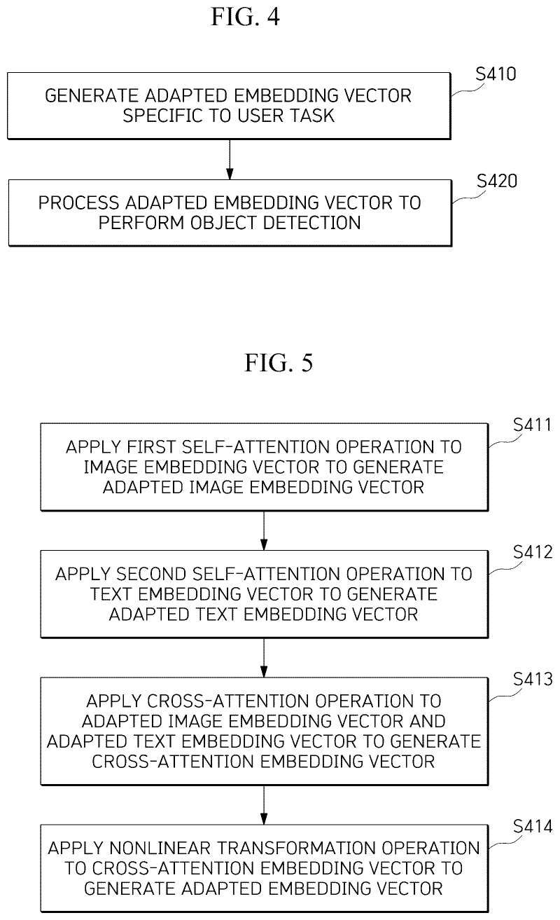

FIG. 4 is a flowchart illustrating an object detection method according to embodiments of the present disclosure.

Referring to FIG. 4, in step S410, an adapted embedding vector specific to a user task may be generated through an embedding transformation operation on a text embedding vector corresponding to an input text and an image embedding vector corresponding to an input image, which are input from the multimodal model 100 and the task-specific adaptation network 200. Here, the embedding transformation operation may include a self-attention operation, a cross-attention operation, and a feed-forward network operation, which are sequentially performed on the image embedding vector and the text embedding vector.

Subsequently, in step S420, the multimodal model 100 may process the input image, the input text, and the adapted embedding vector to perform object detection.

In an embodiment, a step of combining the adapted embedding vector with the text embedding vector from a text encoder (120 of FIGS. 1 and 2) by using a combiner (210 of FIGS. 1 and 2) to provide a combined vector to the multimodal model may be further performed between step S410 and step S420.

FIG. 5 is a detailed flowchart of step S410 illustrated in FIG. 4.

Referring to FIG. 5, step S410 of generating the adapted embedding vector specific to the user task may include the following steps.

First, in step S411, a first self-attention module (201 of FIG. 2) may apply a first self-attention operation, included in the embedding transformation operation, to the image embedding vector to generate an adapted image embedding vector.

Subsequently, in step S412, a second self-attention module (202 of FIG. 2) may apply a second self-attention operation, included in the embedding transformation operation, to the text embedding vector to generate an adapted text embedding vector.

Subsequently, in step S413, a cross-attention module (203 of FIG. 2) may apply a cross-attention operation included in the embedding transformation operation to the adapted image embedding vector and the adapted text embedding vector to generate a cross-attention embedding vector.

Subsequently, in step S414, an MLP module (204 of FIG. 2) may apply a nonlinear transformation operation to the cross-attention embedding vector to generate the adapted embedding vector.

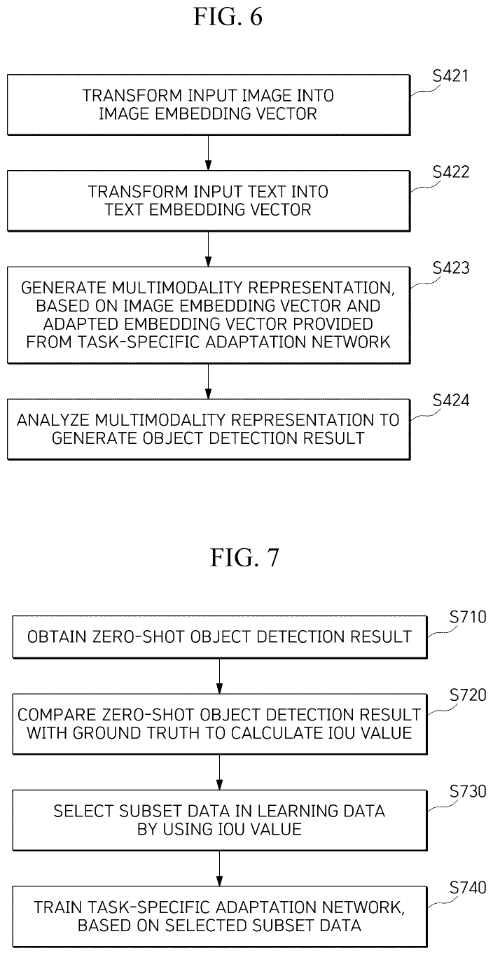

FIG. 6 is a detailed flowchart of step S420 illustrated in FIG. 4.

Referring to FIG. 6, step S420 of processing the adapted embedding vector to perform object detection may include the following steps.

First, in step S421, an image encoder (110 of FIGS. 1 and 2) included in the multimodal model may transform the input image into the image embedding vector.

Subsequently, in step S422, a text encoder (120 of FIGS. 1 and 2) included in the multimodal model may transform the input text into the text embedding vector.

Subsequently, in step S423, a modality combination encoder (140 of FIGS. 1 and 2) may generate multimodality representation, based on the image embedding vector and the adapted embedding vector provided from the task-specific adaptation network.

Subsequently, in step S424, a cross-modality decoder (150 of FIGS. 1 and 2) may analyze the multimodality representation to generate an object detection result, based on a decoding operation.

FIG. 7 is a flowchart illustrating a training process of a task-specific adaptation network according to embodiments of the present disclosure.

Referring to FIG. 7, training of a task-specific adaptation network may be performed by a computing device which includes a memory configured to store an instruction for training execution and a processor configured to execute the instruction.

First, in step S710, the processor may obtain a zero-shot object detection result of the multimodal model.

Subsequently, in step S720, the processor may compare the zero-shot object detection result with a right answer data (ground truth) to calculate an IoU value between the zero-shot object detection result and the right answer data.

Subsequently, in step S730, the processor may select subset data in learning data by using the calculated IoU value. Here, when the IoU value is greater than or equal to a first threshold value, the selected subset data may be classified into EASY data, and when the IoU value is a second threshold value or more and less than the first threshold value, the selected subset data may be classified into MEDIUM data.

Subsequently, in step S740, the processor may train the task-specific adaptation network, based on the selected subset data. Here, in training of the task-specific adaptation network, initial training may be performed based on the EASY data, and then, secondary training may be performed by stepwise adding the MEDIUM data.

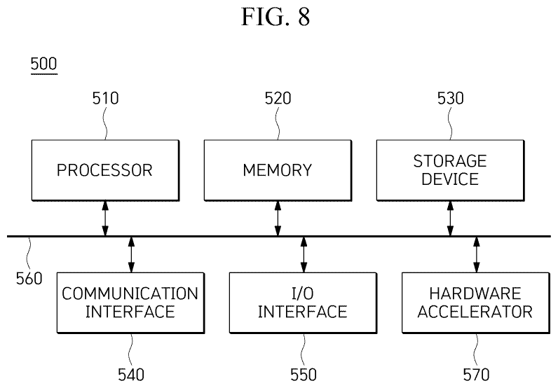

FIG. 8 is a configuration diagram of a computing device for executing and training a large-scale pre-trained AI model performing object detection according to embodiments of the present disclosure.

Referring to FIG. 8, a computing device 500 may include a processor 510, a memory 520, a storage device 530, a communication interface 540, an input/output (I/O) interface 550, and a system bus 560, and moreover, may further include a hardware accelerator 570.

The processor 510 may execute an instruction stored in the memory 520 to perform control to delegate some operations to the hardware accelerator 570, when directly performing all operations defined in FIGS. 1 to 7 or depending on the case. To this end, the processor 510 may control the execution of the image encoder 110, the text encoder 120, the modality combination encoder 140, and the cross-modality decoder 150 of the multimodal model 100 and the self-attention modules 201 and 202, the cross-attention module 203, and the MLP module 204 of the task-specific adaptation network 200.

Moreover, the processor 510 may perform generation of an adapted embedding vector based on an embedding transformation operation (self-attention, cross-attention, and nonlinear transformation) and calculation of an input image, an input text, and an object detection result based on the adapted embedding. An embedding combination providing step based on the combiner 210 may be controlled by the processor 510.

Moreover, the processor 510 may sequentially perform application of first and second self-attention, cross-attention, and nonlinear transformation (FFN/MLP) on image and text embedding.

Moreover, the processor 510 may perform generation of multimodality representation based on combination with image/text encoding and adaptation embedding and calculation of a final object detection result based on decoding.

Moreover, the processor 510 may perform obtainment of a zero-shot result, calculation of IoU corresponding to right answer data, selection of EASY/MEDIUM subset based on an IoU criterion, calculation of loss based on selection data, and parameter update and may thus perform control so that only the task-specific adaptation network 200 is trained (a multimodal model 100 parameter may be fixed).

Furthermore, the processor 510 may perform execution of an optimization algorithm (SGD/Adam/AdamW or the like), calculation of loss (classification: Focal Loss, regression: L1), and changing of inference/learning mode.

The memory 520 may include a volatile memory such as dynamic random access memory (DRAM)/static random access memory (SRAM) and a non-volatile memory such as read only memory (ROM)/flash memory depending on the case. The memory 520 may store an operating system (OS), an instruction for executing the process described above with reference to FIGS. 1 to 7, a model parameter, batch data, and a temporary tensor (image, text embedding, attention weight, IoU value, loss/gradient, optimizer state, etc.) and may thus function as an operation buffer of the processor 510.

The storage device 530 may be a non-transitory computer-readable recording medium such an solid state drive (SSD), a hard disk drive (HDD), flash memory, or optic/magnetic recording medium and may permanently store a learning data set, right answer data, subset data, log, experiment metadata, a model checkpoint, and a final parameter, and depending on the case, the processor 510 may load and store data.

The communication interface 540 may include Ethernet, Wi-Fi, Bluetooth, mobile communication (4G/5G), and other wired/wireless modules, and based on control by the processor 510, the communication interface 540 may transmit or receive data (for example, learning data, a zero-shot result, statistic, parameter update, etc.) to or from an external server/cloud/edge device.

The I/O interface 550 may collect an input image 10 and an input text 20 from a camera/sensor/keyboard/pointer/touch and may provide an object detection result, a learning log, and a performance indicator through a display/speaker/network.

The system bus 560 may transfer data/control signal between the processor 510, the memory 520, the storage device 530, the communication interface 540, the I/O interface 550, and the hardware accelerator 570.

The hardware accelerator 570 may be an optional element and may include one or more of a graphics processing unit (GPU), a tensor processing unit (TPU), a neural processing unit (NPU), a field programmable gate array (FPGA), and an application specific integrated circuit (ASIC), and moreover, may accelerate operations such as matrix multiplication, attention, convolution, and normalization.

According to embodiments of the present disclosure, unlike a conventional training method based on simple data collection, a model may be adapted to a specific task required by a user while maintaining a performance of a conventional model pre-trained with massive data. Accordingly, effective additional training may be performed with only a small amount of training data, and data having similar and different personalities may also be used, thereby enhancing training efficiency.

Moreover, for example, even in a case which processes various tasks such as “fallen person detection” or “banner detection” in a closed-circuit television (CCTV) environment, a performance of a pre-trained model may be maintained while adapting to a characteristic changed based on each camera or environment. Accordingly, a degradation in performance in a specific environment may be prevented, and moreover, an enhanced result may be obtained.

Furthermore, the present disclosure may maintain an operation path capable of using a zero-shot model, and thus, in a case where a model adapted to a specific task is tested in a completely different environment, a generalization capability of the zero-shot model may be used again. Accordingly, the reusability and flexibility of a model may increase.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A computing device including a memory configured to store an instruction for executing and training a large-scale pre-trained artificial intelligence (AI) model performing object detection and a processor configured to execute the instruction, the large-scale pre-trained AI model executed and trained by the processor comprising:
a multimodal model configured to process different modality inputs including an input image and an input text and an adapted embedding vector specific to a user task to perform the object detection; and
a task-specific adaptation network configured to generate the adapted embedding vector and provide the adapted embedding vector to the multimodal model, based on an embedding transformation operation on an image embedding vector and a text embedding vector respectively corresponding to the input image and the input text input from the multimodal model.

2. The computing device of claim 1, wherein the embedding transformation operation comprises a self-attention operation, a cross-attention operation, and a nonlinear transformation operation.

3. The computing device of claim 1, wherein the task-specific adaptation network comprises:
a first self-attention module configured to apply a first self-attention included in the embedding transformation operation to the image embedding vector to generate an adapted image embedding vector;
a second self-attention module configured to apply a second self-attention operation included in the embedding transformation operation to the text embedding vector to generate an adapted text embedding vector;
a cross-attention module configured to apply a cross-attention operation included in the embedding transformation operation to the adapted image embedding vector and the adapted text embedding vector to generate a cross-attention embedding vector; and
a multi-layer perceptron module configured to apply a nonlinear transformation operation to the cross-attention embedding vector to generate the adapted embedding vector.

4. The computing device of claim 3, wherein the first self-attention module analyzes a correlation between feature elements of the image embedding vector to generate the adapted image embedding vector where a relatively important feature is emphasized and an undesired feature is restrained, based on the first self-attention operation.

5. The computing device of claim 3, wherein the second self-attention module analyzes a correlation between feature elements of the text embedding vector to generate the adapted text embedding vector where a relatively important feature is emphasized and an undesired feature is restrained, based on the second self-attention operation.

6. The computing device of claim 3, wherein the cross-attention module generates the cross-attention embedding vector in which a semantic correlation between the adapted image embedding vector and the adapted text embedding vector is reflected, based on the cross-attention operation.

7. The computing device of claim 3, wherein the nonlinear transformation operation comprises a feed-forward network operation or a multilayer perceptron operation.

8. The computing device of claim 1, further comprising a combiner configured to combine the text embedding vector with the adapted embedding vector again to provide a combined vector to the multimodal model.

9. The computing device of claim 1, wherein the multimodal model comprises:
an image encoder configured to transform the input image into the image embedding vector;
a text encoder configured to transform the input text into the text embedding vector;
a modality combination encoder configured to generate multimodality representation, based on the image embedding vector and the adapted embedding vector; and
a cross-modality decoder configured to analyze the multimodality representation to generate an object detection result, based on a decoding operation.

10. The computing device of claim 1, wherein the task-specific adaptation network is trained based on subset data which is selected in learning data with respect to an IoU value calculated by comparing a zero-shot object detection result with right answer data.

11. The computing device of claim 10, wherein, when the IoU value is greater than or equal to a first threshold value, the selected subset data is classified into EASY data, and when the IoU value is a second threshold value or more and less than the first threshold value, the selected subset data is classified into MEDIUM data, and
in training of the task-specific adaptation network, initial training is performed based on the EASY data, and then, secondary training is performed by stepwise adding the MEDIUM data.

12. The computing device of claim 1, wherein a loss function used in training of the task-specific adaptation network comprises L1 loss for bounding box regression and focal loss.

13. An object detection method performed by a computing device including a memory configured to store an instruction for object detection and a processor configured to execute the instruction, the object detection method comprising:
a step of generating an adapted embedding vector specific to a user task by using a task-specific adaptation network executed by the processor, based on an embedding transformation operation on an image embedding vector and a text embedding vector respectively corresponding to an input image and an input text input from a multimodal model executed by the processor; and
a step of processing the input image, the input text, and the adapted embedding vector by using the multimodal model executed by the processor to perform the object detection.

14. The object detection method of claim 13, wherein the embedding transformation operation comprises a self-attention operation, a cross-attention operation, and a nonlinear transformation operation, which are sequentially performed on the image embedding vector and the text embedding vector.

15. The object detection method of claim 13, wherein the step of generating the adapted embedding vector comprises:
a step of applying a first self-attention operation included in the embedding transformation operation to the image embedding vector to generate an adapted image embedding vector by using a first self-attention module;
a step of applying a second self-attention included in the embedding transformation operation to the text embedding vector to generate an adapted text embedding vector by using a second self-attention module;
a step of applying a cross-attention operation included in the embedding transformation operation to the adapted image embedding vector and the adapted text embedding vector to generate a cross-attention embedding vector by using a cross-attention module; and
a step of applying a nonlinear transformation operation to the cross-attention embedding vector to generate the adapted embedding vector by using a multi-layer perceptron module.

16. The object detection method of claim 13, further comprising a step of combining the text embedding vector with the adapted embedding vector to provide a combined vector to the multimodal model by using a combiner executed by the processor, between the step of generating the adapted embedding vector specific and the step of performing the object detection.

17. The object detection method of claim 13, wherein the step of performing the object detection comprises:
a step of transforming the input image into the image embedding vector by using an image encoder included in the multimodal model;
a step of transforming the input text into the text embedding vector by using a text encoder included in the multimodal model;
a step of generating multimodality representation by using a modality combination encoder included in the multimodal model, based on the image embedding vector and the adapted embedding vector provided from the task-specific adaptation network; and
a step of analyzing the multimodality representation to generate an object detection result by using a cross-modality decoder included in the multimodal model, based on a decoding operation.

18. A training method of a task-specific adaptation network connected to a multimodal model performed by a computing device including a memory configured to store an instruction for training execution and a processor configured to execute the instruction, the training method comprising:
a step of obtaining a zero-shot object detection result of the multimodal model;
a step of comparing the zero-shot object detection result with right answer data (ground truth) to calculate an IoU value between the zero-shot object detection result and the right answer data;
a step of selecting subset data in learning data by using the calculated IoU value; and
a step of training the task-specific adaptation network, based on the selected subset data.

19. The training method of claim 18, wherein the step of selecting the subset data comprises a step of classifying the selected subset data into EASY data when the IoU value is greater than or equal to a first threshold value and classifying the selected subset data into MEDIUM data when the IoU value is a second threshold value or more and less than the first threshold value.

20. The training method of claim 19, wherein the step of training the task-specific adaptation network comprises a step of, after initial training is performed based on the EASY data, performing secondary training by stepwise adding the MEDIUM data.
